(19) United States
(12) Patent Application Publication
(10) Pub. No.: US 2021/0039582 A1
(43) Pub. Date: Feb. 11, 2021

(54) AIRBAG PACKAGE WITH IMPROVED PACKAGING

(71) Applicant: ZF Passive Safety Systems US Inc., Washington, MI (US)

(72) Inventors: Richard Patton, Ortonville, MI (US); Dylan Moran, Rochester-Hills, MI (US); Daniel Sutherland, Richmond, MI (US)

(21) Appl. No.: 16/533,845

(22) Filed: Aug. 7, 2019

(51) Int. Cl. B60R 21/237; B60R 21/232

(52) U.S. Cl. CPC B60R 21/237; B60R 21/232

(57) ABSTRACT

An apparatus for helping to protect an occupant of a vehicle includes a curtain airbag rolled about a central longitudinal axis. A pair of longitudinally extending creases are formed on the rolled curtain airbag. Each of the creases extend from an outer surface of the rolled curtain airbag inward toward the central longitudinal axis of the rolled curtain airbag. A method for packaging a curtain airbag of a vehicle safety system includes rolling the curtain airbag about a central longitudinal axis. Creases are formed in radially opposite, longitudinally extending portions of an outer surface of the rolled curtain airbag inward toward the central longitudinal axis.

### FIELD OF THE INVENTION

The invention relates to an apparatus for helping to protect an occupant of a vehicle and a method for packaging the apparatus in the vehicle. More particularly, the invention relates to a curtain airbag inflatable between a vehicle occupant and a side structure of a vehicle and a method for packaging the curtain airbag.

### BACKGROUND OF THE INVENTION

It is known to inflate an inflatable vehicle occupant protection device to help protect a vehicle occupant in the event of a vehicle collision. One particular type of inflatable vehicle occupant protection device is a curtain airbag that has a stored condition in which the airbag is fixed to vehicle structure along the vehicle roof at or adjacent the intersection of a side structure of the vehicle and the vehicle roof. In response to an event for which occupant protection is desired, such as a side impact or a vehicle rollover, the curtain airbag is configured to inflate and deploy from the stored condition away from the vehicle roof downward inside the passenger compartment. The curtain airbag, when inflated, is positioned between a vehicle occupant and the side structure of the vehicle.

Curtain airbags can be rolled and/or folded to place the curtain airbag in the stored condition. To properly store the rolled curtain airbag can, however, require a relatively large space. In some vehicle architectures, it may be difficult to achieve a desired headroom and interior aesthetic while, at the same time, accommodating a large curtain airbag package. The large curtain airbag packages can also interfere with other structures concealed by the headliner, such as wiring and HVAC ductwork. It can therefore be desirable to reduce the size of the curtain airbag package.

### SUMMARY OF THE INVENTION

According to one aspect, an apparatus for helping to protect an occupant of a vehicle includes a curtain airbag rolled about a central longitudinal axis. A pair of longitudinally extending creases are formed on the rolled curtain airbag. Each of the creases extend from an outer surface of the rolled curtain airbag inward toward the central longitudinal axis of the rolled curtain airbag.

According to another aspect, alone or in combination with any other aspect, each of the creases can comprise radially opposite, longitudinally extending portions of the outer surface of the rolled curtain airbag pressed inward toward the central longitudinal axis of the rolled curtain airbag.

According to another aspect, alone or in combination with any other aspect, the creases can comprise radially opposite, longitudinally extending portions of the rolled curtain airbag that are pinned inward toward each other.

According to another aspect, alone or in combination with any other aspect, the creases can define an upper lobe and a lower lobe of the rolled curtain airbag. The upper and lower lobes can be separated by the inward extending creases.

According to another aspect, alone or in combination with any other aspect, the upper and lower lobes can be compressed toward each other to further form the creases. The apparatus can further comprise a wrapping that encircles the rolled and creased curtain airbag and maintains the compressed condition of the lobes and the creases.

According to another aspect, alone or in combination with any other aspect, the rolled curtain airbag can define a central space that extends longitudinally along the central longitudinal axis. The creases can extend inward into the central space.

According to another aspect, alone or in combination with any other aspect, the creases can engage each other in the central space.

According to another aspect, alone or in combination with any other aspect, the curtain airbag can be generally I-shaped when viewed in cross-section.

According to another aspect, alone or in combination with any other aspect, the curtain airbag can be inflatable from a stored condition in the vehicle to a deployed condition in which the curtain airbag is positioned between a side structure of the vehicle and the vehicle occupant.

According to another aspect, alone or in combination with any other aspect, a method for packaging a curtain airbag of a vehicle safety system can comprise rolling the curtain airbag about a central longitudinal axis. Creases can be formed in radially opposite, longitudinally extending portions of an outer surface of the rolled curtain airbag inward toward the central longitudinal axis.

According to another aspect, alone or in combination with any other aspect, the step of forming creases can comprise positioning a pair of longitudinally extending blades on radially opposite sides of the rolled curtain airbag and moving the blades in a creasing direction toward each other and toward the central longitudinal axis to form the creases.

According to another aspect, alone or in combination with any other aspect, the upper and lower lobes can be compressed toward each other in a direction perpendicular to a creasing direction to compress the curtain airbag and further define the creases. A volume of the curtain airbag can decrease as the curtain airbag is compressed. The rolled, creased, and compressed curtain airbag can be encircled with a wrapping to maintain the rolled, creased, and compressed condition of the curtain airbag.

According to another aspect, alone or in combination with any other aspect, the rolled and creased curtain airbag can be placed between two compression elements. At least one of the compression elements can be driven toward the other of the compression elements and toward the curtain airbag in a direction perpendicular to the creasing direction to compress the curtain airbag and further define the creases.

According to another aspect, alone or in combination with any other aspect, the compression elements can be components of a compression die.

According to another aspect, alone or in combination with any other aspect, a first one of the compression elements can comprise a mold having a trough and a second one of the compression elements can comprise a pressing die. A portion of the rolled and creased curtain airbag can be placed into the trough of the mold. With a portion of the rolled and creased curtain airbag placed in the trough, the pressing die can be urged into the trough to engage and compress the rolled and creased curtain airbag between the pressing die and the mold.

According to another aspect, alone or in combination with any other aspect, a portion of the rolled curtain airbag can be placed into an extrusion machine. The extrusion machine can perform the steps of forming creases in radially opposite, longitudinally extending portions of the outer surface of the rolled curtain airbag in a creasing direction toward the central longitudinal axis, and compressing the rolled curtain airbag in a direction perpendicular to the creasing direction to compress the curtain airbag and further define the creases.

According to another aspect, alone or in combination with any other aspect, the rolled and creased curtain airbag can be generally I-shaped when viewed in cross-section.

### BRIEF DESCRIPTION OF THE DRAWINGS

The foregoing and other features of the invention will become apparent to one skilled in the art to which the invention relates upon consideration of the following description of the invention with reference to the accompanying drawings, in which:

FIG. 1 is a schematic side view illustrating an apparatus for helping to protect an occupant of a vehicle;

FIG. 2 is a sectional view of an element of the apparatus of FIG. 1, in a first configuration;

FIG. 3 is a sectional view of an element of the apparatus of FIG. 1, in a second configuration; and

FIGS. 4-12 illustrate a method for packaging a portion of the apparatus of FIG. 1.

### DETAILED DESCRIPTION OF THE INVENTION

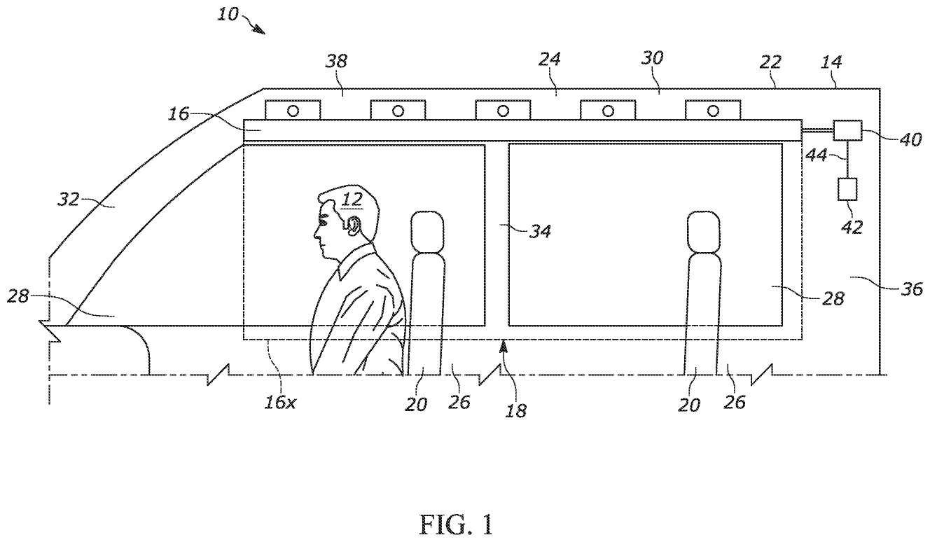

An apparatus 10 for helping to protect an occupant 12 of a vehicle 14 includes an inflatable vehicle occupant protection device 16 in the form of an airbag, such as a curtain airbag, for helping to protect the vehicle occupant. In the embodiment illustrated in FIG. 1, the curtain airbag 16 is shown on a passenger side 18 of the vehicle 14 for helping to protect passenger side vehicle occupants. Those skilled in the art will appreciate that the apparatus 10 disclosed herein could be adapted for use on a driver side (not shown) of the vehicle 14 for helping to protect driver side vehicle occupants.

The vehicle 14 includes at least one vehicle seat 20 for the vehicle occupants 12, a vehicle roof 22, and a side structure 24. The vehicle 14 has two rows of seating which help dictate the configuration of the side structure 24. In the example configuration shown in FIG. 1, the side structure 24 of the vehicle 14 includes two vehicle doors 26, two side windows 28, a roof rail 30, an A-pillar 32, a B-pillar 34, and a C-pillar 36. The apparatus 10 can, however, be applied to vehicles having any number of rows, and thus any side structure configuration.

The curtain airbag 16 can be constructed of any suitable material, such as nylon (e.g., woven nylon 6-6 yarns), and can be constructed in any suitable manner. For example, the curtain airbag 16 may have a one-piece woven (OPW) construction in which the curtain airbag is woven as a single piece of material. As another example, the curtain airbag 16 can include more than one piece of material. If more than one piece is used, the pieces can be interconnected by known means, such as stitching, ultrasonic welding, heat bonding, or adhesives, to form the curtain airbag 16. The curtain airbag 16 can be uncoated, coated with a material, such as a gas impermeable urethane, or laminated with a material, such as a gas impermeable film. The curtain airbag 16 thus can have a gas-tight or substantially gas-tight construction. Those skilled in the art will appreciate that alternative materials, such as polyester yarn, and alternatives coatings, such as silicone, can also be used to construct the curtain airbag 16.

As shown in the example configuration of FIGS. 1, the curtain airbag 16 is mounted to a support structure 38 of the vehicle 14. When the curtain airbag 16 is in a stored condition, the curtain airbag is rolled and/or folded and contained in the support structure 38. The curtain airbag 16 is inflatable and deployable from the stored condition away from the support structure 38 and toward a deployed condition (indicated by dashed lines at 16x in FIG. 1) in which the curtain airbag is positioned between the side structure 24 and the vehicle occupant 12. The support structure 38 can be any structure in the vehicle 14 that will accommodate the curtain airbag 16 being deployed therefrom so that the deployed curtain airbag is positioned between the side structure 24 and the vehicle occupant 12. In the example configuration shown in FIGS. 1, the support structure 38 is the roof rail 30. The curtain airbag 16 can be mounted to the roof rail 38 in any desired manner.

An inflator 40 is operatively connected to the curtain airbag 16 and is actuatable to provide inflation fluid for inflating the curtain airbag from the stored condition to the deployed condition. The inflator 40 can be of any known type, such as stored gas, solid propellant, augmented, or hybrid. An airbag controller 42 can be operatively connected to the inflator 40 via lead wires 44. The airbag controller 42 is configured to actuate the inflator 40 in response to sensing the occurrence of an event for which occupant protection is desired, such as a collision.

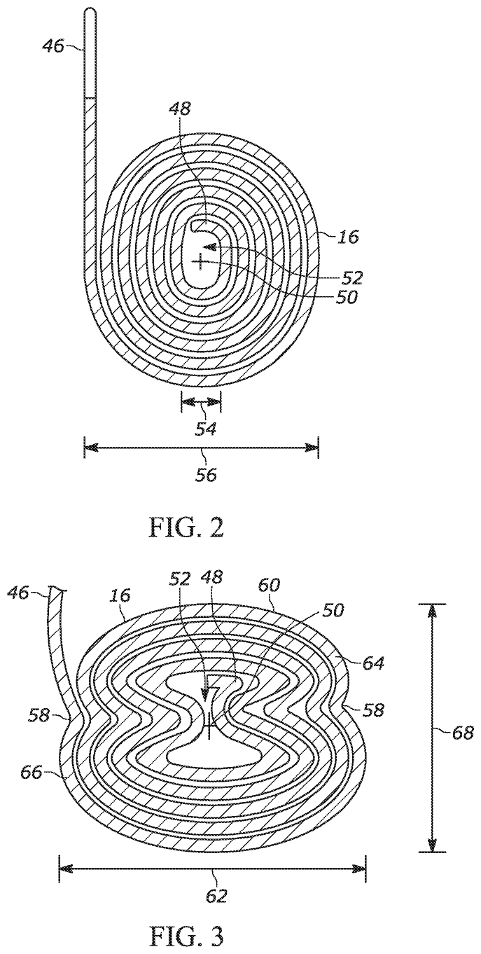

FIG. 2 depicts an example configuration of a rolled curtain airbag 16. The curtain airbag 16 of FIG. 2 includes an upper end portion 46, which is configured to be attached to the roof rail 30, and a lower end portion 48, which has been rolled about a central longitudinal axis 50 of the curtain airbag toward the upper end portion. The rolled curtain airbag 16 defines a central space 52 that extends longitudinally along the central longitudinal axis 50. The central space 52 can be formed as a result of utilizing a rolling instrument, such as a bar, to assist a user in rolling the curtain airbag 16. The curtain airbag 16 can be rolled about the bar so that the bar occupies a space, i.e., the central space 52, along the central longitudinal axis 50 of the rolled curtain airbag. The central space 52 is exposed after the bar has been removed from the rolled curtain airbag 16.

Because of the central space 52, the rolled curtain airbag 16 has an inner diameter 54 (i.e., the diameter of the central space) and an outer diameter 56. The inner and outer diameters of the rolled curtain airbag can be determined by the manner in which the curtain airbag is rolled. In the example configuration of FIG. 2, the inner diameter 54 of the rolled curtain airbag 16 is about 27 millimeters and the outer diameter 56 of the rolled curtain airbag is about 34 millimeters. A space in the roof rail 30 in which the rolled curtain airbag 16 is stored in must be larger than the outer diameter 56 of the rolled curtain airbag, e.g., larger than 34 millimeters. A 34 millimeter rolled curtain airbag 16 can have a volume that is too large for certain vehicle modules to store. Further, in vehicle modules that can adequately store the volume of the 34 millimeter rolled curtain airbag 16, it can still be difficult to access portions of the vehicle adjacent to the stored curtain airbag.

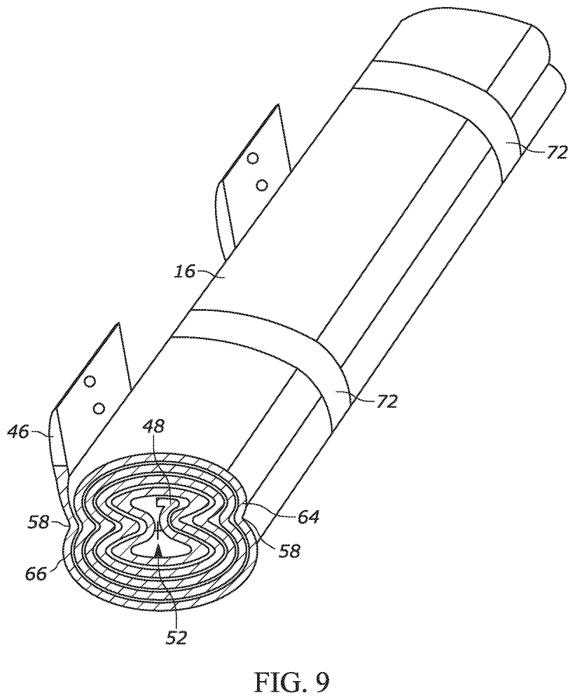

As shown in FIG. 2, the central space 52 makes up an unutilized space in the rolled curtain airbag 16. Reducing the size of the central space 52 will result in the volume of the rolled curtain airbag 16 being reduced. FIG. 3 depicts the rolled curtain airbag 16 after the size of the central space 52 has been reduced. As shown in the example configuration of FIG. 3, a pair of longitudinally extending creases 58 are formed on the rolled curtain airbag 16. Each of the creases 58 comprise radially opposite, longitudinally extending portions of an outer surface 60 of the rolled curtain airbag 16 that are pressed and/or pinned inward toward the central longitudinal axis 50 of the rolled curtain airbag (see also FIG. 9). Although the curtain airbag 16 in the example configuration of FIG. 3 has one pair of creases 58, the curtain airbag can have two or more pairs of creases wherein each pair of creases can comprise radially opposite, longitudinally extending portions of the outer surface 60 of the rolled curtain airbag. Further, although in the example configuration of FIG. 3, the curtain airbag 16 has two creases 58, the curtain airbag can have any number of creases.

Each of the creases 58 can longitudinally extend along an entire length of the rolled curtain airbag 16, can longitudinally extend along a portion of the rolled curtain airbag that is less than the entire length of the rolled curtain airbag, or can comprise a plurality of separate creases that each longitudinally extend along a portion of the entire length of the rolled curtain airbag. As shown in FIG. 3, the creases 58 extend from the outer surface 60 of the rolled curtain airbag 16 inward into the central space 52 and can engage each other in the central space. Creasing the rolled curtain airbag 16 reduces a width 62 of the rolled curtain airbag as portions of the outer surface 60 of the rolled curtain airbag are driven inward into the central space 52.

The creases 58 define and separate upper and lower lobes 64, 66 of the rolled and creased curtain airbag 16. As shown in FIG. 3, the formation of the upper and lower lobes 64, 66 produce a generally I-shaped configuration for the creased portion of the rolled and creased curtain airbag 16 when viewed in cross-section. The upper and lower lobes 64, 66 can be compressed toward each other to further form the creases and reduce a height 68 of the rolled and creased curtain airbag 16.

As shown in FIG. 3, the size of central space 52 has been reduced from that shown in FIG. 2 due to portions of the rolled curtain airbag 16 being creased and/or compressed toward the central longitudinal axis 50 and into the central space. The rolled, creased, and compressed curtain airbag 16 of FIG. 3 is smaller in cross-section than the rolled curtain airbag of FIG. 2. The rolled, creased, and compressed curtain airbag 16 in the example configuration of FIG. 3 has a height 68 of about 24 millimeters (the result of the compression) and a width 62 of about 21 millimeters (the result of the creasing). The length of the curtain airbag 16 does not significantly change during the creasing and compression of the rolled curtain airbag. Therefore, because the rolled, creased, and compressed curtain airbag 16 of FIG. 3 is smaller in cross-section than the rolled curtain airbag of FIG. 2 and substantially has the same length as the rolled curtain airbag of FIG. 2, the volume of the rolled, creased, and compressed curtain airbag 16 of FIG. 3 is less than the volume of the rolled curtain airbag of FIG. 2. Thus, by reducing the size of the central space 52 through creasing and compressing the rolled curtain airbag 16, the volume of the rolled curtain airbag can be reduced.

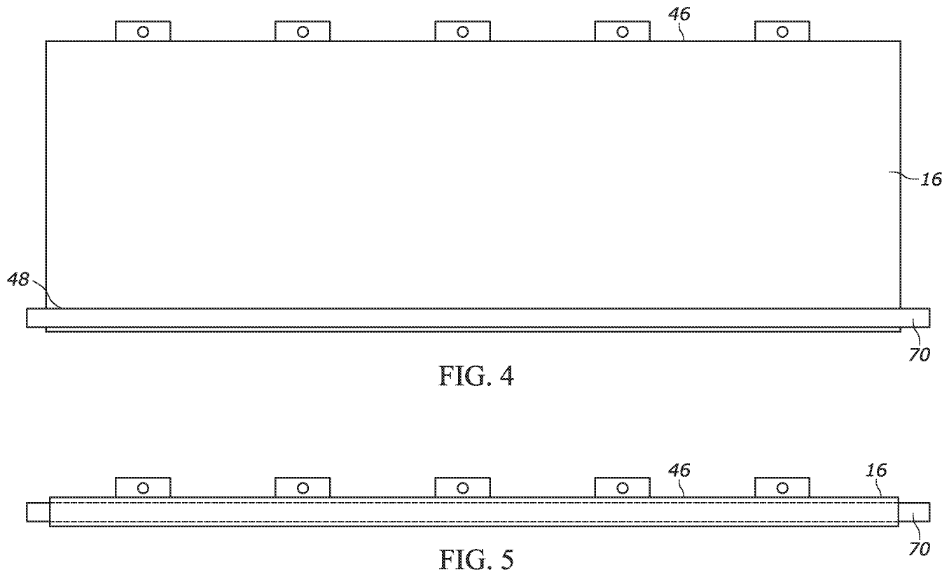

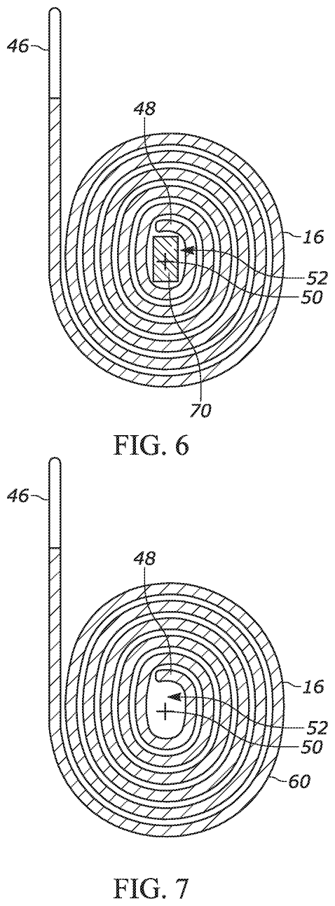

FIGS. 4-12 illustrate an example processes by which the curtain airbag 16 can be packaged. These example processes are not intended to limit the manner in which the curtain airbag 16 is packaged. Those skilled in the art will appreciate that certain steps of the below example processes can be performed before and/or after certain other steps of the processes whether expressly stated, shown, or not. As shown in FIG. 4, the curtain airbag 16 is maneuvered, such as by being flatly spread, to a generally flattened configuration. A rolling instrument 70, such as a bar, can be positioned on the lower end portion 48 of the flattened curtain airbag 16. As shown in FIGS. 4-6, the lower end portion 48 of the curtain airbag 16 is rolled about the bar 70 and about the central longitudinal axis 50 toward the upper end portion 46 of the rolled curtain airbag. The rolled curtain airbag can be flip folded (not shown) at the upper end portion 46 of the curtain airbag 16 to accommodate certain vehicle models and/or deployment trajectories. As shown in FIG. 7, once the curtain airbag 16 has been rolled, the bar 70 can be removed, which exposes the central space 52.

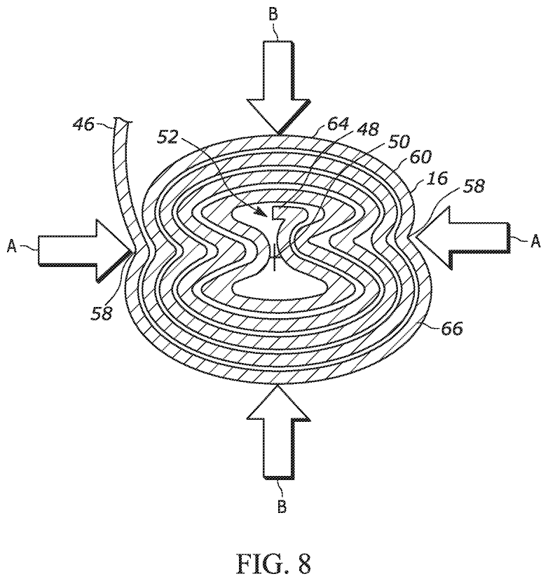

As shown in FIG. 8, with the curtain airbag 16 rolled, the creases 58 can be formed in radially opposite, longitudinally extending portions of the outer surface 60 of the rolled curtain airbag in any desired manner. The creases 58 extend in a creasing direction, as indicated by arrows “A” in FIG. 8, inward toward the central longitudinal axis 50 and define the upper and lower lobes 64, 66 of the rolled curtain airbag 16. Once the creases 58 are formed, the upper and lower lobes 64, 66 can be compressed toward each other in a compressing direction, which is perpendicular to the creasing direction and indicated by arrows “B” in FIG. 8, to compress the curtain airbag 16 and further define the creases. The volume of the curtain airbag 16 decreases as the curtain airbag is compressed. As shown in FIG. 9, the rolled, creased, and compressed curtain airbag 16 can be encircled with a wrapping 72 to maintain the rolled, creased, and compressed condition of the curtain airbag. The wrapping 72 can comprise at least one piece of tape and/or a cover wrap that encircles the rolled, creased, and compressed curtain airbag 16. The rolled, creased, and compressed curtain airbag can be extruded directly into the cover wrap.

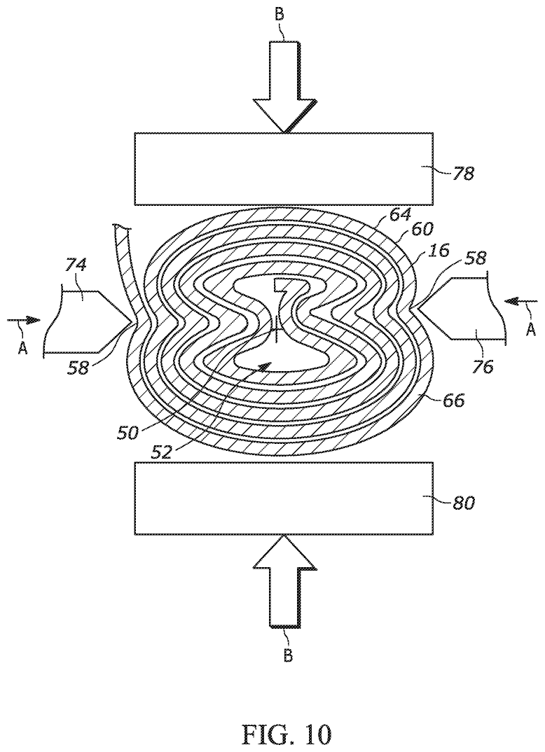

FIG. 10 depicts a first example technique by which the rolled curtain airbag 16 can be creased and compressed. The creases 58 can be formed by positioning a pair of longitudinally extending blades 74, 76 on radially opposite sides of the rolled curtain airbag 16. Once in position, the blades 74, 76 can be moved in the creasing direction A toward each other and toward the central longitudinal axis 50. The blades 74, 76 press and/or pin portions of the outer surface 60 of the rolled curtain airbag 16 inward toward the central longitudinal axis 50 of the rolled curtain airbag to form the creases 58. The rolled and creased curtain airbag 16 can then be positioned between two compression elements 78, 80. The two compression elements 78, 80 can be components of a compression die 82. With the rolled and creased curtain airbag 16 positioned between the two compression elements 78, 80, at least one of the compression elements 78, 80 can be driven toward the other of the compression elements 78, 80 and toward the curtain airbag in the compressing direction B to compress the curtain airbag and further define the creases 58. Instead of forming the creases 58 and then compressing the rolled and creased curtain airbag 16, the blades 74, 76 form the creases while the compression elements 78, 80 compress the rolled curtain airbag 16.

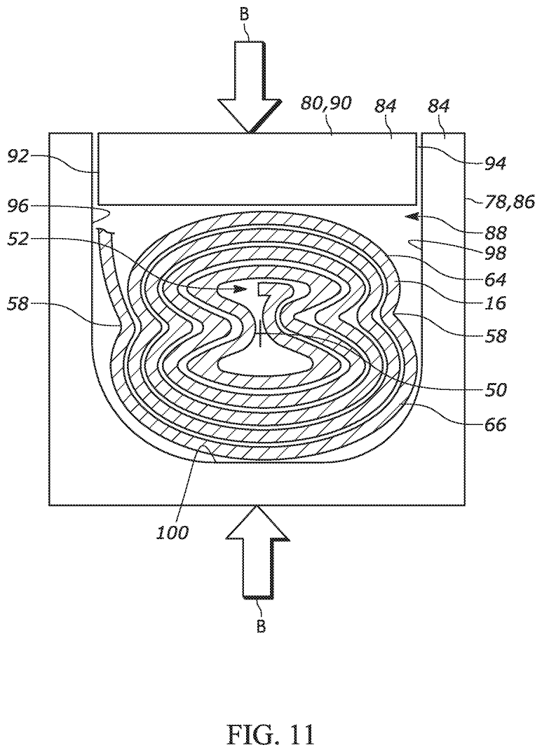

FIG. 11 depicts a second example technique by which the rolled curtain airbag 16 can be creased and compressed. The second technique utilizes a pressing mold 84 which has two compression elements 78, 80. A first compression element 78 comprises a mold 86 having a trough 88. A second compression element 80 comprises a pressing die 90 dimensioned to fit into the trough 88 so as to compress a rolled curtain airbag 16 received in the trough.

In the example technique of FIG. 11, the creases 58 can be formed in the rolled curtain airbag 16 in any desired manner prior to the rolled curtain airbag being inserted into the trough 88. The rolled and creased curtain airbag 16 is then inserted into the trough 88 of the mold 86. Due to the shape of the trough 88, the rolled and creased curtain airbag 16 can be enclosed by the mold 86 on at least three sides of the curtain airbag.

The pressing die 90 is then inserted into the trough 88, wherein vertical outer surfaces 92, 94 of the pressing die slide along vertical side faces 96, 98 of the trough. The pressing die 90 is urged toward the rolled and creased curtain airbag 16 and toward a lower surface 100 of the trough 88 to engage and compress the rolled and creased curtain airbag in the compressing direction B between the pressing die and the mold 86.

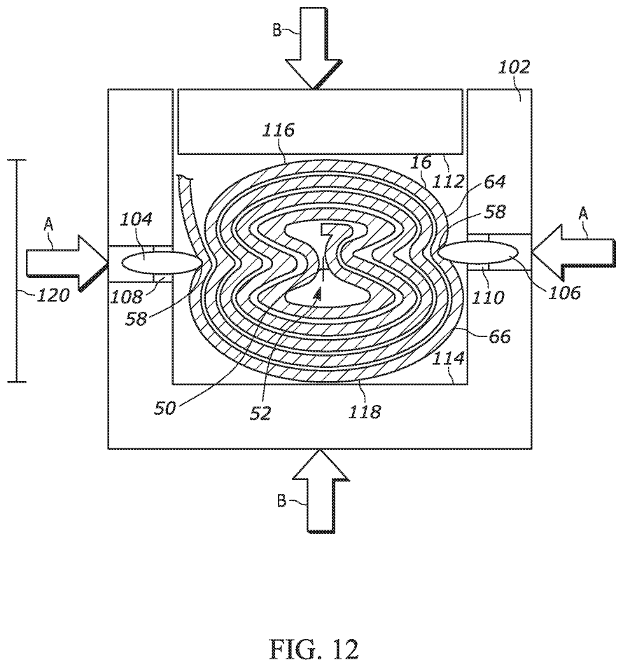

FIG. 12 depicts a third example technique by which the rolled curtain airbag 16 can be creased and compressed. The third technique utilizes an extrusion machine 102 in which the rolled curtain airbag 16 can be fed into. The extrusion machine 102 can have a pair of longitudinally extending creasing members 104, 106 that are positioned so that they are on radially opposite sides of a rolled curtain airbag 16 that has been fed into the extrusion machine. In the example configuration of FIG. 12, the creasing members 104, 106 can be rotatable and configured to form the creases 58 in the rolled curtain airbag 16 while also helping to drive the rolled curtain airbag through the extrusion machine 102. Each of the rotatable creasing members 104, 106 are rotatable about a support post 108, 110. The support posts 108, 110 can be configured to be moved in the creasing direction A and in a direction opposite to the creasing direction. The movement of the support posts 108, 110, and accordingly the rotatable creasing members 104, 106, allow a user to form creases 58 in certain longitudinal portions of the rolled curtain airbag 16 and prevent creases from being formed in certain other portions of curtain airbag. For example, the rotatable creasing members 104, 106 can be driven in the creasing direction A toward the position shown in FIG. 12 to crease longitudinal portions of the rolled curtain airbag 16 when desired. The rotatable creasing members 104, 106 can also be driven in a direction opposite to the creasing direction A from the position shown in FIG. 12 so that the rotatable creasing members do not significantly contact the rolled curtain airbag 16 and do not form creases 58 in the rolled curtain airbag when desired.

To compress the rolled curtain airbag 16, the extrusion machine 102 includes upper and lower compressing surfaces 112, 114. The upper compressing surface 112 is configured to engage an upper surface 116 of the rolled curtain airbag 16. The lower compressing surface 114 is configured to engage a lower surface 118 of the rolled curtain airbag 16. A height 120 between the upper and lower compressing surfaces 112, 114 can gradually decrease along a length of the extrusion machine 102 so that as the rolled curtain airbag 16 travels through the extrusion machine the rolled curtain airbag is compressed in the compressing direction B. Alternatively, the height 120 between the upper and lower compressing surfaces 112, 114 can be configured to be selectably decreased and increased. In this configuration, at least one of the compressing surfaces 112, 114 can be driven toward the other of the compressing surfaces 112, 114 and toward the curtain airbag 16 to compress the curtain airbag in the compressing direction B and further define the creases 58.

From the above description of the invention, those skilled in the art will perceive improvements, changes and modifications. Such improvements, changes and modifications within the skill of the art are intended to be covered by the appended claims.

1. An apparatus for helping to protect an occupant of a vehicle, comprising:
a curtain airbag rolled about a central longitudinal axis; and
a pair of longitudinally extending creases formed on the rolled curtain airbag, each of the creases extending from an outer surface of the rolled curtain airbag inward toward the central longitudinal axis of the rolled curtain airbag.

2. The apparatus recited in claim 1, wherein each of the creases comprise radially opposite, longitudinally extending portions of the outer surface of the rolled curtain airbag pressed inward toward the central longitudinal axis of the rolled curtain airbag.

3. The apparatus recited in claim 1, wherein the creases comprise radially opposite, longitudinally extending portions of the rolled curtain airbag that are pinned inward toward each other.

4. The apparatus recited in claim 1, wherein the creases define an upper lobe and a lower lobe of the rolled curtain airbag, the upper and lower lobes being separated by the inward extending creases.

5. The apparatus recited in claim 4, wherein the upper and lower lobes are compressed toward each other to further form the creases, and wherein the apparatus further comprises a wrapping that encircles the rolled and creased curtain airbag and maintains the compressed condition of the lobes and the creases.

6. The apparatus recited in claim 1, wherein the rolled curtain airbag defines a central space that extends longitudinally along the central longitudinal axis, and wherein the creases extend inward into the central space.

7. The apparatus recited in claim 6, wherein the creases engage each other in the central space.

8. The apparatus recited in claim 1, wherein the curtain airbag is generally I-shaped when viewed in cross-section.

9. The apparatus recited in claim 1, wherein the curtain airbag is inflatable from a stored condition in the vehicle to a deployed condition in which the curtain airbag is positioned between a side structure of the vehicle and the vehicle occupant.

10. A method for packaging a curtain airbag of a vehicle safety system, comprising:
rolling the curtain airbag about a central longitudinal axis; and
forming creases in radially opposite, longitudinally extending portions of an outer surface of the rolled curtain airbag inward toward the central longitudinal axis.

11. The method recited in claim 10, wherein the rolled curtain airbag defines a central space that extends longitudinally along the central longitudinal axis, and wherein the creases extend inward into the central space.

12. The method recited in claim 11, wherein the creases engage each other in the central space.

13. The method recited in claim 10, wherein the step of forming creases comprises positioning a pair of longitudinally extending blades on radially opposite sides of the rolled curtain airbag and moving the blades in a creasing direction toward each other and toward the central longitudinal axis to form the creases.

14. The method recited in claim 10, wherein the creases define an upper and a lower lobe of the rolled curtain airbag, the upper and lower lobes being separated by the inward extending creases.

15. The method recited in claim 14, the method further comprising:
compressing the upper and lower lobes toward each other in a direction perpendicular to a creasing direction to compress the curtain airbag and further define the creases, a volume of the curtain airbag decreasing as the curtain airbag is compressed; and
encircling the rolled, creased, and compressed curtain airbag with a wrapping to maintain the rolled, creased, and compressed condition of the curtain airbag.

16. The method recited in claim 13, further comprising:
placing the rolled and creased curtain airbag between two compression elements; and
driving at least one of the compression elements toward the other of the compression elements and toward the curtain airbag in a direction perpendicular to the creasing direction to compress the curtain airbag and further define the creases.

17. The method recited in claim 16, wherein the compression elements are components of a compression die.

18. The method recited in claim 16, wherein a first one of the compression elements comprises a mold having a trough and a second one of the compression elements comprises a pressing die, the method further comprising:
placing a portion of the rolled and creased curtain airbag into the trough of the mold; and
with a portion of the rolled and creased curtain airbag placed in the trough, urging the pressing die into the trough to engage and compress the rolled and creased curtain airbag between the pressing die and the mold.

19. The method recited in claim 10, further comprising:
placing a portion of the rolled curtain airbag into an extrusion machine, the extrusion machine performing the steps of
forming creases in radially opposite, longitudinally extending portions of the outer surface of the rolled curtain airbag in a creasing direction toward the central longitudinal axis, and
compressing the rolled curtain airbag in a direction perpendicular to the creasing direction to compress the curtain airbag and further define the creases.

20. The method recited in claim 10, wherein the rolled and creased curtain airbag is generally I-shaped when viewed in cross-section.
